(19) United States
(12) Patent Application Publication
(10) Pub. No.: US 2010/0250825 A1
(43) Pub. Date: Sep. 30, 2010

(54) METHOD AND APPARATUS FOR MOUNTING FILES AND DIRECTORIES TO A LOCAL OR REMOTE HOST

(75) Inventors: Wei Chen, Shanghai (CN); Qiang Fu, Shanghai (CN); Wen Long Lan, Shanghai (CN); Xian Dong Meng, Shanghai (CN); Jian Xu, San Jose, CA (US)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORPORATION, ARMONK, NY (US)

(21) Appl. No.: 12/726,572

(22) Filed: Mar. 18, 2010

(30) Foreign Application Priority Data
Mar. 31, 2009 (CN) 200910130300.0

(51) Int. Cl. G06F 12/10

(52) U.S. Cl. 711/6; 711/206; 711/E12.061

(57) ABSTRACT

A method and apparatus are disclosed for mounting at least one file to a host. The method comprises creating a virtual device image comprising a logical block address table. The method further comprises writing information regarding a block address and a size of an occupied space of the at least one file into the logical block address table, the information being calculated according to a format of a normal device image file system. Moreover, the method comprises recording in the logical block address table a file address map relationship comprising a map from the block address of the at least one file to a real position of the at least one file outside of the virtual device image. Furthermore, the method comprises mounting the virtual device image to the host. At least one directory may be mounted in addition to or in lieu of the at least one file.

### RELATED APPLICATION

This application claims priority under 35 U.S.C. §119 to Patent Application No. 200910130300.0 filed Mar. 31, 2009, the entire text of which is specifically incorporated by reference herein.

### TECHNICAL FIELD

The various embodiments described herein relate to remote system management with network storage. In particular, the various embodiments relate to an apparatus and method for mounting and reading files or directories by using a virtual device image.

### BACKGROUND

A remote drive presents storage devices (e.g., a floppy drive, a CD-ROM drive, a USB drive, and device image files) of a local computer to a remote host as physical devices directly attached to the remote host. Hardware devices of the remote drive are connected to the remote host via its USB interface. Client software of the remote drive on the local computer presents devices or device images of the local computer to the remote host via hardware and related software on the remote host. Moreover, the client software transfers commands and data between the local computer and the remote host. The remote host considers the storage devices loaded via the remote drive as native physical devices, and the remote drive provides storage devices or images of the local computer as native physical devices of the remote host.

The remote drive can be used to install an operating system, update firmware, and exchange files. The remote drive is available in multiple products for system management purposes.

FIG. 1 illustrates an exemplary scenario in which the local drive is mounted to a remote host by using the remote drive. A local computer 101 comprises a CD-ROM drive, a floppy disk drive, a USB drive, and device image files. A remote host 103 comprises a remote drive (not shown), and the remote host 103 and the remote drive are connected to the local computer 101 via a network 102. Client software of the remote drive runs in the local computer 101. The local computer 101 is able to mount device drives or device image files used therein to the remote host 103 as, e.g., disk drives (C:), (D:), (E:), (F:), etc. to be used in the remote host 103 by the client software of the remote drive.

The remote host 103 may directly access files on the storage device of the local computer 101 presented to the remote host 103 via the remote drive. The remote host 103 can access files that are not on storage devices mounted to the remote host 103 by encapsulating such files as ISO 9660 image files and directly mounting them to the remote host 103. ISO 9660 is a widely-supported image file format. The ISO 9660 specification defines a file system for CD-ROM media and supports different computer operating systems such as UNIX, Windows, and Mac OS so that data may be exchanged among different platforms.

FIG. 2 illustrates a main structure of an ISO 9660 file system, i.e., logical sector. A logical sector is divided into several logical parts. The first part is the reserved field. Although not clearly defined in the ISO 9660 specification, the reserved field generally is used to store boot information. The second part is the volume descriptor, which includes the ISO 9660 file system information. Other kinds of descriptors optionally can be used to record non-ISO file system information following the volume descriptor. Following the non-ISO file system information is a volume contents part comprising directory information such as a root directory, root directory files, a subdirectory, subdirectory files, etc.

FIG. 3 illustrates a directory structure of the ISO 9660 file system. A directory record is a data structure that describes the characteristics of a file or directory. Directory records themselves are of variable length. Attributes for the file described by the directory record are stored in the directory record itself. Hereinafter, the term “ISO image file” will be used for “ISO 9660 image file” for simplicity purposes.

Although conventional remote drive technology allows a local computer to share device images with a remote host, there are significant limitations regarding the conventional technology. Firstly, a remote drive cannot mount arbitrary files or directories of the local computer directly to a remote host; rather, the remote drive can only mount physical devices or device image files (e.g., floppy disk drive, CD-ROM drive, USB drive, ISO 9660 image, etc.) to a remote host. If the remote drive in accordance with the conventional technology is to share arbitrary files or directories of the local computer, a first method involves copying the files to be shared onto the physical storage device of the local computer provided to the remote host by the remote drive. A second method involves encapsulating the files into a device image file so that the files are made available to the remote host after the device image file is mounted via the remote drive.

Secondly, if the second aforementioned method is used, i.e. the files to be mounted are encapsulated into a device image file in order to share files or directories with the host via the remote drive, a new floppy or ISO image file that contains specific files must be created and manually mounted, even if only one or a few files are to be shared. If there is no ready-to-use ISO/floppy image maker tool, arbitrary file and directory sharing via the remote drive operation is impossible. Furthermore, creation of an image file requires special knowledge of ISO image and related tool software.

Finally, creation of a large ISO image file takes substantial time and occupies at least the same amount of disk space as its original contents. For instance, sharing a 4 GB file will require at least 4 GB of additional space for generating an ISO image file that includes the file to be shared, and creating the ISO image file takes substantial time.

Locally encapsulating ISO image files also may be necessary in situations other than remote sharing. For example, some software requires loading via CD-ROM; in such case, if the local computer does not contain a CD-ROM drive, an ISO image file may be needed.

As previously mentioned, the conventional method for creating such image file involves copying all of the contents of the selected files and directories into the image file, which may take substantial time and may result in almost double storage space for selected files on the storage system. Thus, the conventional method may result in a waste of significant time and storage space. If the purpose for creating the image file is merely to temporarily mount files to the host, creating a real ISO image file may be unduly inconvenient.

### SUMMARY OF THE INVENTION

According to one aspect of the various embodiments described herein, a method is provided for mounting at least one file to a local or remote host. The method comprises creating a virtual device image comprising a logical block address table; writing information regarding a block address and a size of an occupied space of the at least one file into the logical block address table, the information being calculated according to a format of a normal device image file system; recording in the logical block address table a file address map relationship comprising a map from the block address of the at least one file to a real position of the at least one file located outside of the virtual device image; and mounting the virtual device image to the local or remote host. The virtual device image further may comprise a virtual image file header. Additionally, the method may comprise generating a directory record of the at least one file in the virtual image file header and writing the information regarding the block address and the size of the occupied space of the at least one file into the directory record of the at least one file.

Moreover, the method may comprise writing information regarding a block address and a size of an occupied space of at least one directory to be mounted into the logical block address table, the information being calculated according to a format of a normal device image file system. The method further may comprise recording in the logical block address table a directory address map relationship comprising a map from the block address of the at least one directory to a real position of the at least one directory in the virtual image file header. Furthermore, the method may comprise generating a directory record of the at least one directory in the virtual image file header and writing the information regarding the block address and the size of the occupied space of the at least one directory into the directory record of the at least one directory. Additionally, the method may comprise placing the at least one directory into the real position of the at least one directory according to the directory address map relationship.

Further, the virtual image file header may comprise a volume descriptor, and the method may comprise adjusting a position of the volume descriptor in the virtual image file header from a block address of the volume descriptor to a real position of the volume descriptor in the virtual image file header. Also, information regarding the block address and a size of an occupied space of the volume descriptor, as well as a map from the block address of the volume descriptor to the real position of the volume descriptor, may be recorded in the logical block address table.

According to a further aspect of the various embodiments described herein, an apparatus is provided for mounting at least one file to a local or remote host. The apparatus comprises a creation unit for creating a virtual device image comprising a logical block address table. The apparatus further comprises a processing unit for writing information regarding a block address and a size of an occupied space of the at least one file into the logical block address table, the information being calculated according to a format of a normal device image file system. In addition, the processing unit records in the logical block address table a file address map relationship comprising a map from the block address of the at least one file to a real position of the at least one file located outside of the virtual device image. Furthermore, the apparatus comprises a drive for mounting the virtual device image to the local or remote host. The virtual device image further may comprise a virtual image file header. Additionally, the apparatus may comprise a directory record generation unit for generating a directory record of the at least one file in the virtual image file header and for writing the information regarding the block address and the size of the occupied space of the at least one file into the directory record of the at least one file.

Moreover, the processing unit of the apparatus may write information regarding a block address and a size of an occupied space of at least one directory to be mounted into the logical block address table, the information being calculated according to a format of a normal device image file system. Also, the processing unit may record in the logical block address table a directory address map relationship comprising a map from the block address of the at least one directory to a real position of the at least one directory in the virtual image file header. Further, the directory record generation unit of the apparatus may generate a directory record of the at least one directory in the virtual image file header and may write the information regarding the block address and the size of the occupied space of the at least one directory into the directory record of the at least one directory. In addition, the processing unit may place the at least one directory into the real position of the at least one directory according to the directory address map relationship.

Furthermore, the virtual image file header may comprise a volume descriptor, and the processing unit may adjust a position of the volume descriptor in the virtual image file header from a block address of the volume descriptor to a real position of the volume descriptor in the virtual image file header. Additionally, information regarding the block address and a size of an occupied space of the volume descriptor and a map from the block address of the volume descriptor to the real position of the volume descriptor may be recorded in the logical block address table.

According to a further aspect of the various embodiments described herein, a method is provided for reading a virtual device image used to mount at least one file to a local or remote host. The method comprises receiving a command from a read device regarding content to be read; in response to a determination that a device to be read is a virtual device image, obtaining a real position of the content to be read in the virtual device image according to a file address map relationship comprising a map from a block address of the at least one file to a real position of the at least one file located outside of the virtual device image; and reading the content from the real position of the at least one file. Moreover, a logical block address table of the virtual file image may comprise the file address map relationship and information regarding the block address and a size of an occupied space of the at least one file, the information being calculated according to a format of a normal device image file system. Furthermore, the virtual device image may comprise a virtual image file header including a generated directory record of the at least one file, and the directory record of the at least one file may comprise the information regarding the block address and the size of the occupied space of the at least one file.

Additionally, the logical block address table may comprise information regarding a block address and a size of an occupied space of at least one directory to be mounted, the information being calculated according to a format of a normal device image file system. Furthermore, the logical block address table may comprise a directory address map relationship including a map from the block address of the at least one directory to a real position of the at least one directory in the virtual image file header. Further, the virtual image file header may comprise a generated directory record of the at least one directory, and the directory record of the at least one directory may comprise the information regarding the block address and the size of the occupied space of the at least one directory. Also, a position of the at least one directory in the virtual image file header may be adjusted from the block address of the at least one directory to the real position of the at least one directory.

According to a further aspect of the various embodiments described herein, an apparatus is provided for reading a virtual device image used to mount at least one file to a local or remote host. The apparatus comprises a command reception unit for receiving a command from a read device regarding content to be read and for determining whether a device to be read in accordance with the command is a virtual device image. The apparatus further comprises a address transformation unit for obtaining, in response to a determination that the device to be read is a virtual device image, a real position of the content to be read in the virtual device image according to a file address map relationship comprising a map from a block address of the at least one file to a real position of the at least one file located outside of the virtual device image. In addition, the apparatus comprises a read unit for reading the content from the real position of the at least one file.

Via the various embodiments described herein, one or more files and/or directories may be mounted more conveniently to a host via the remote drive. By utilizing a virtual image file in accordance with the various embodiments, it is unnecessary to create a real device image including the content of the selected files and/or directories. Instead, only a virtual image is created to reference the content, and thus no real storage space need be allocated. Mounting arbitrary files and/or directories to a remote host via the various embodiments may save time and storage space, regardless of the size of the files and/or directories.

### BRIEF DESCRIPTION OF THE DRAWINGS

From the following detailed description of exemplary embodiments, aspects and advantages of the various embodiments will become apparent. The various embodiments are to be explained further with reference to the attached drawings, in which:

FIG. 1 is a diagram of a system in which a drive is remotely mounted to a host;

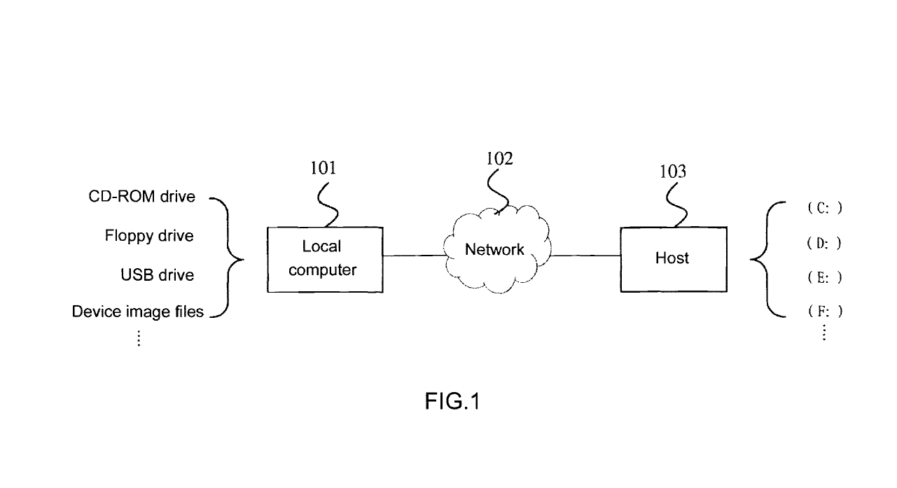

FIG. 2 is a diagram of a main structure of an ISO 9660 file system;

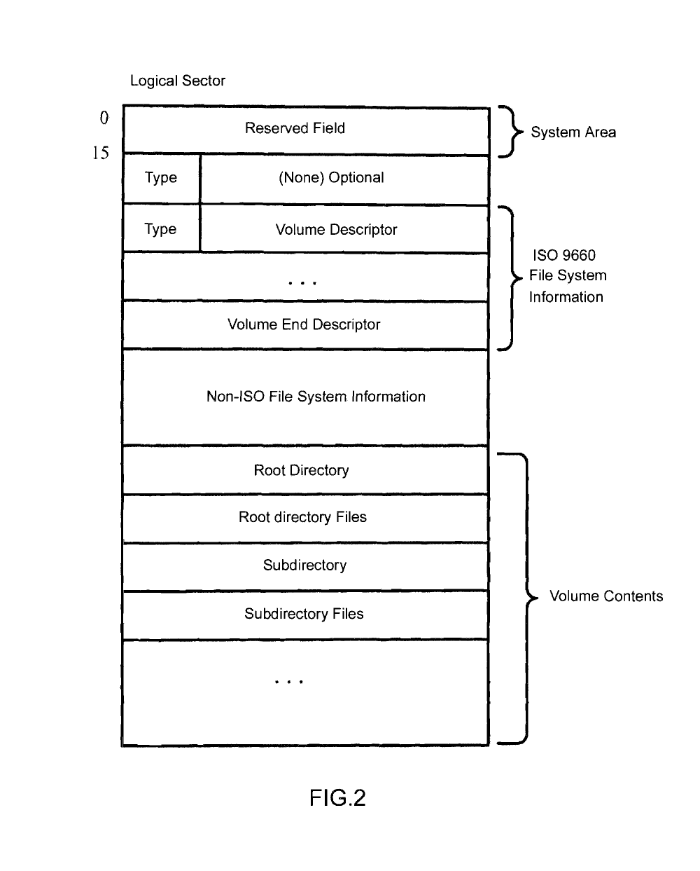

FIG. 3 is a diagram of a directory structure of the ISO 9660 file system;

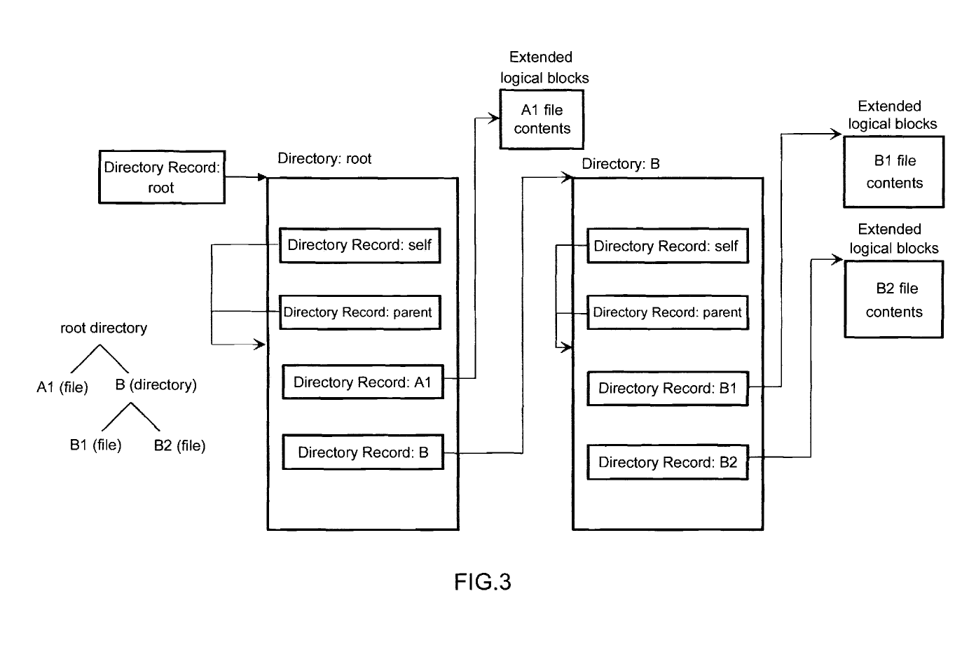

FIG. 4 is a diagram of a directory and file structure in a virtual device image in accordance with an exemplary embodiment;

FIG. 5 is a diagram of the structure of a virtual device image in accordance with an exemplary embodiment;

FIG. 6 is a flowchart of a method for mounting at least one file and/or directory to a local or remote host in accordance with an exemplary embodiment;

FIG. 7 is a diagram of the difference between an ISO image file and a virtual image file header in accordance with an exemplary embodiment;

FIG. 8 is a diagram of the structure of a virtual device image in accordance with an exemplary embodiment;

FIG. 9 is a diagram of a system for mounting files and/or directories in accordance with an exemplary embodiment;

FIG. 10 is a structural diagram of an apparatus for mounting files or directories to a local or remote host and/or for reading the contents of the files or directories from the host in accordance with an exemplary embodiment;

FIG. 11 is a flowchart illustrating a method for reading a virtual device image in accordance with an exemplary embodiment; and

FIG. 12 is a diagram of a system for reading files or directories mounted to a local or remote host in accordance with an exemplary embodiment.

### DETAILED DESCRIPTION

Technical aspects of the various embodiments are described in detail herein with reference to exemplary embodiments. However, these exemplary embodiments may be modified in various formats, and the scope of the various embodiments is not limited to these specific exemplary embodiments. A method for mounting at least one file and/or directory to a host in accordance with an exemplary embodiment involves selecting the at least one file and/or directory to be mounted, transforming the least one file and/or directory into a virtual device image (file), (e.g., a virtual floppy image, a virtual ISO image, or a virtual device image), and then mounting the resulting virtual device image to the host via a remote drive. Subsequently, the host may detect the remote drive and may find the corresponding file and/directory thereon.

The virtual device image presented by the various embodiments described herein is different from a normal (i.e., real) device image. The virtual device image includes only minimal necessary file system information, i.e., a logical block address table and optionally a virtual image file header.

The virtual device image does not include specific content of the file. Different types of drives (file systems) have different virtual image formats. For example, a virtual ISO image file is used to simulate a CD/DVD drive. However, the virtual device image in accordance with the various embodiments is applicable to any format of device image.

Terms to be used throughout the description are explained immediately below.

A block address (offset address) refers to a logical address for respective components of the virtual device image, such as a volume descriptor, respective directories, files, etc. The block addresses discussed regarding the virtual device image herein are analogous to block addresses within a normal device image. When reading or writing data associated with these components, a local or remote host can only identify the block addresses for these components. The above block addresses are recorded in the logical block address table and/or directory records of the above components. Here, the block address for a directory refers to the block address for specific content of the directory. The content of the directory refers to information included in the directory itself (e.g., a hierarchical structure of the directory, the files included in the directory, etc.), but the specific content of a file is not included in the directory.

In addition, a map refers to the relationship between the block addresses for the respective components of the virtual device image and the real positions of these components, which are recorded in corresponding locations in the logical block address table.

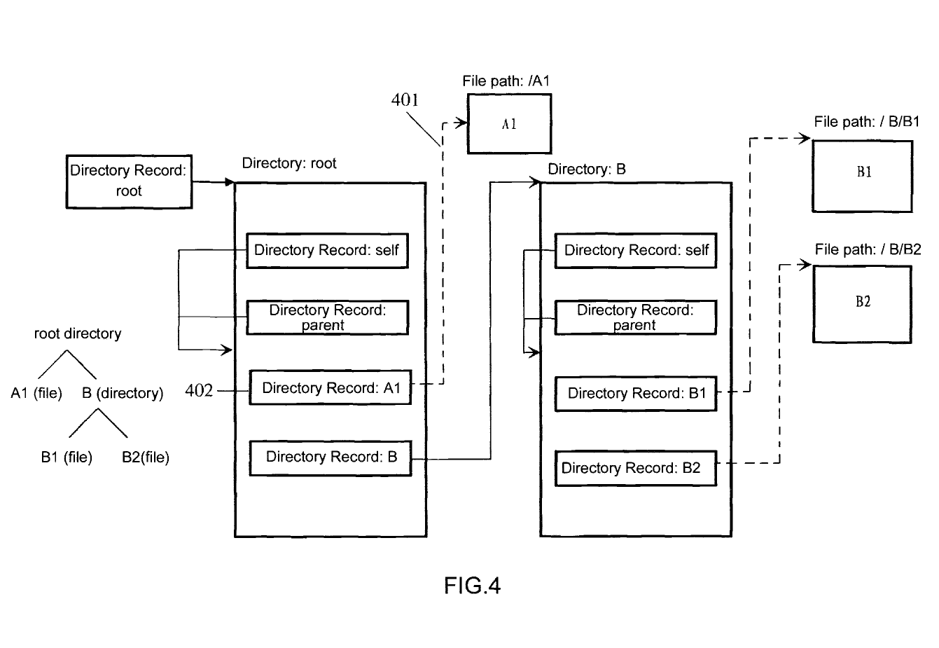

FIG. 4 illustrates an organizational structure in a virtual device image according to an exemplary embodiment. In FIG. 4, file A1, file B1, and file B2 are located outside of the virtual device image. A record 402 of the file A1 in the virtual device image, which may be either a directory record or a record in another form, points to the corresponding file A1 via a pointer (dashed line) 401. Similarly, records of the files B1 and B2 respectively point to the corresponding files B1 and B2.

A link between a record in the virtual device image and the content of the corresponding file may comprise the address for the first block (i.e., the block address) of the file in that virtual device image and the number of blocks that the file occupies. According to another exemplary embodiment, such a link also may be the full path for the external file. For example, the path for the file A1 is “/A1”, the path for the file B1 is “/B/B1”, and the path for the file B2 is “/B/B2”. These paths indicate the actual files accessible by a local computer (e.g., the local computer 101).

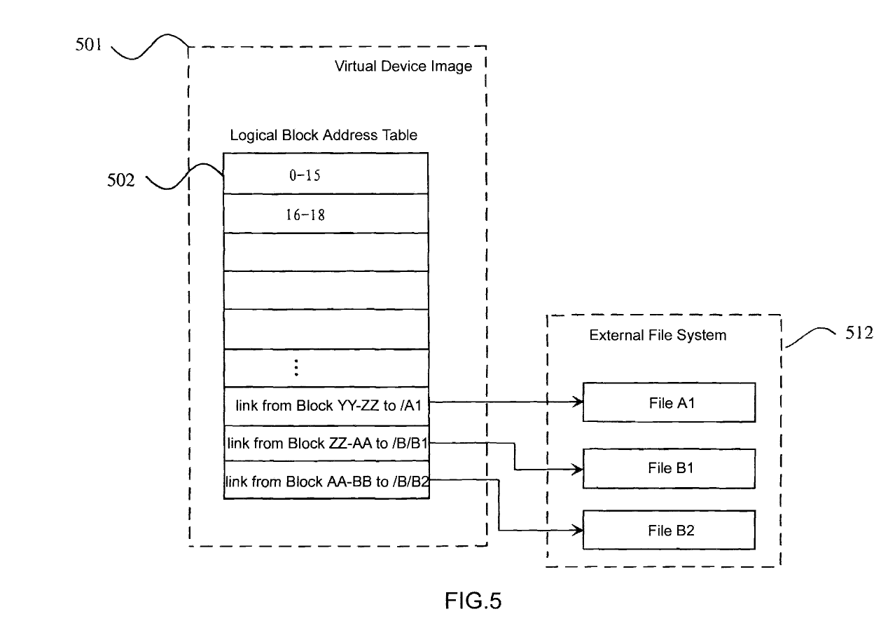

FIG. 5 illustrates the structure of a virtual device image 501 according to an exemplary embodiment. As shown in FIG. 5, the virtual device image 501 comprises a logical block address table 502, and the logical block address table 502 interfaces with an external file system 512. All of the links as illustrated in FIG. 4 are represented and maintained in the logical block address table 502. The logical block address table 502 is a set of maps between block addresses and the real positions of the related data (contents of directories and specific contents of files).

Specifically, since the block addresses for files and/or directories to be mounted are adjusted with respect to a normal device image when the virtual device image 501 is created, their real positions and their block addresses in the virtual device image 501 may be different from those in a normal device image. Therefore, maps from the block addresses in a normal device image for the files and/or directories to be mounted to their real positions in the virtual device image 501 are formed in the logical block address table 502.

The real positions of the specific contents of the file A1, the file B1, and the file B2 are their addresses in the external file system 512. Maps from the block addresses of the file A1, the file B1, and the file B2 to their real positions in the external file system 512 are formed in the logical block address table 502, and there are link paths pointing to the external file system 512 in the maps. For example, there is a path “/A1” pointing to the specific content of the file A1 in the block address YY-ZZ for the file A1 of the logical block address table 502, there is a path “/B/B1” pointing to the specific content of the file B1 in the block address ZZ-AA for the file B1 of the logical block address table 502, and there is a path “/B/B2” pointing to the specific content of the file B2 in the block address AA-BB for the file B2 of the logical block address table 502. The specific content of the target files such as the file A1, the file B1, and the file B2 are stored in the external file system 512.

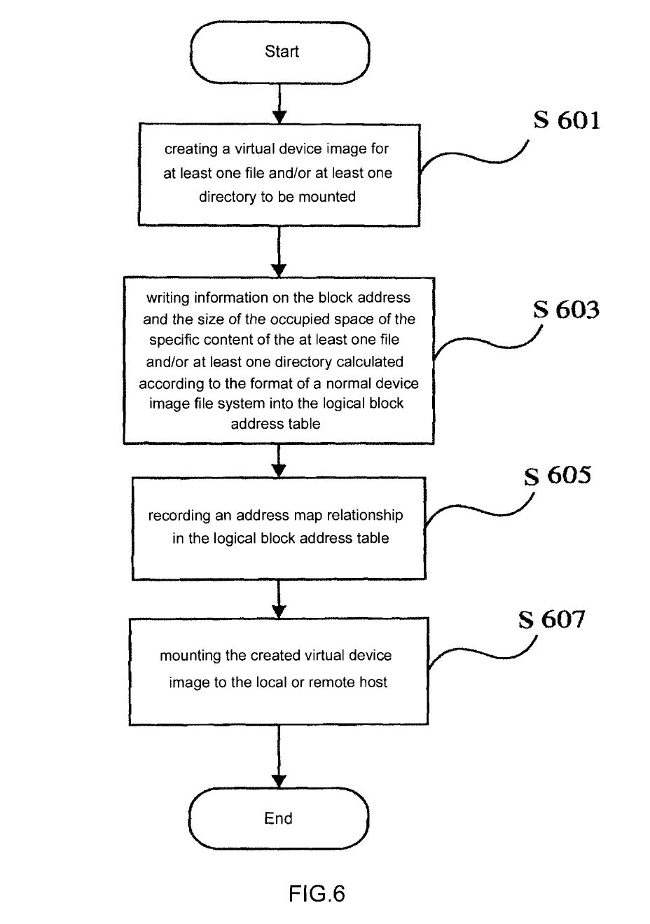

FIG. 6 is a flowchart of a method for mounting at least one file and/or directory to a local or remote host according to an exemplary embodiment. At step S601, a virtual device image (e.g., the virtual device image 501 comprising the logical block address table 502) is created for at least one file and/or directory to be mounted. Subsequently, at step S603, information regarding the block address and the size of the occupied space of the specific content of the at least one file and/or directory calculated according to a format of a normal device image file system is written into the logical block address table 502. Then, at step S605, the address map relationship is recorded in the logical block address table 502. For any file, the above address map relationship comprises the map from the block address of the file to the real position of the specific content of the file located outside of the virtual device image 501 (i.e., the file address map relationship). For any directory, the above address map relationship comprises the map from the block address of the directory to the real position of the specific content of the directory in the virtual device image 501 (i.e., the directory address map relationship). The address map relationship for any file in a directory may be considered as a kind of file address map relationship. Subsequently, at step S607, the created virtual device image 501 is mounted to a local or remote host. Then, the process ends. Here, the real position of the specific content of a file and/or a file included in a directory is located outside of the virtual device image 501, for example in the external file system 512.

Via the above method, a virtual device image can be utilized without creating a real (normal) device image including the content data of the one or more files and/or directories processed. Therefore, no allocation of real storage space is required. Using the above method, mounting one or more arbitrary files and/or directories to a host may save time and storage space, regardless of the size of the one or more files and/or directories.

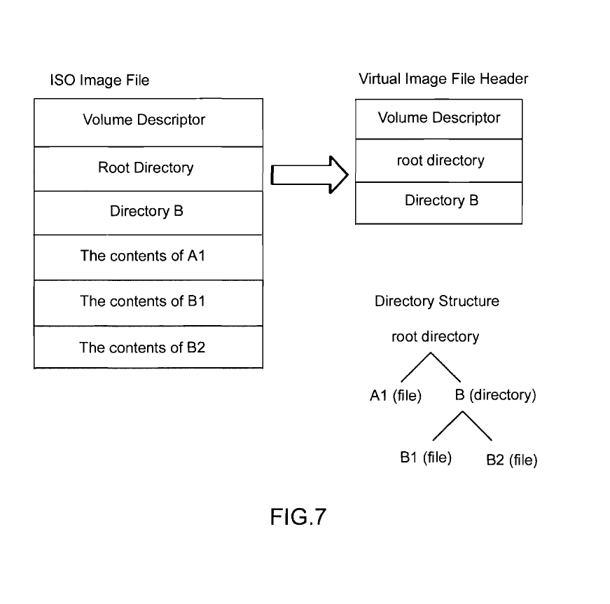

According to another exemplary embodiment, a virtual device image further comprises a virtual image file header. FIG. 7 illustrates the relationship between a normal device image such as an ISO image file and a virtual image file header according to an exemplary embodiment. The main difference between the two structures is that for the virtual image file header, only the volume descriptor and respective directories are included, and the specific contents of all files are located outside of the virtual device image. In the virtual image file header, since only parts of original components (the volume descriptor, directories, etc.) are included, and since the addresses for the components in the virtual image file header are rearranged, a mechanism is designed in the logical block address table so that the block addresses of the components in the normal device image are mapped to the real block addresses in the virtual image file header.

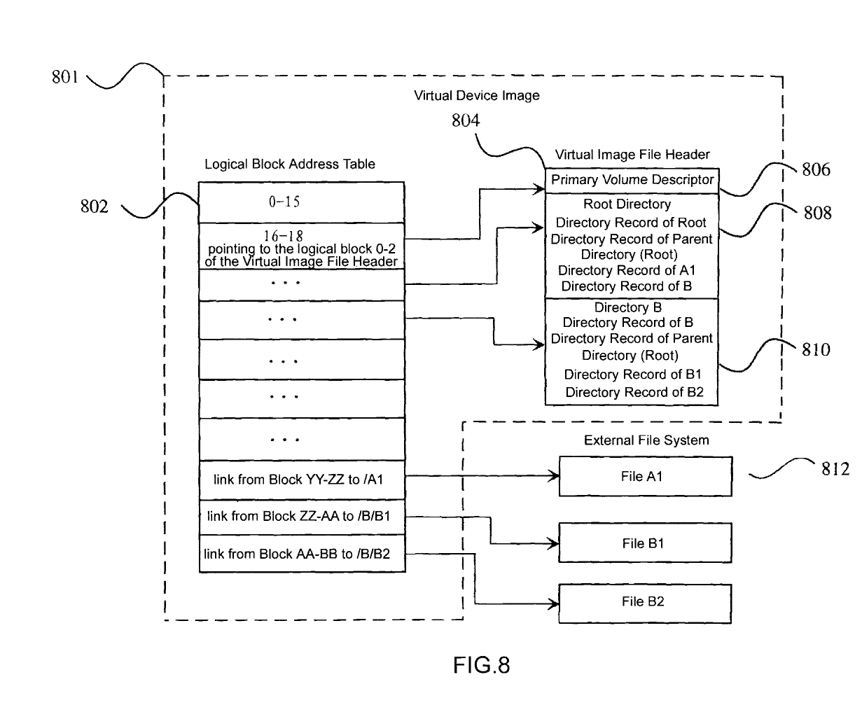

FIG. 8 is an example of a virtual device image 801 in which the relationship between a logical block address table 802 and a virtual image file header 804 is shown. As shown in FIG. 8, the virtual device image 801 comprises the logical block address table 802 and the virtual image file header 804. As further described herein, there are link paths between the logical block address table 802 and an external file system 812. The virtual image file header 804 comprises volume descriptors 806 (which may include a primary volume descriptor, a supplementary volume descriptor, a volume partition descriptor, a start-up record, a volume descriptor end, and other items), a root directory 808, a subdirectory B 810, etc. The block address of the volume descriptor 806 is 16-18, representing its block address in the normal device image. As illustrated in FIG. 8, this block address is recorded in the logical block address table 802. The root directory 808 may comprise a directory record for the root directory, a directory record for the parent (root) directory, a directory record for the file A1, a directory record for Subdirectory B, etc. The directory record for each directory or file may comprise the block address of the directory or file, and such block address is also recorded in the logical block address table 802. The block address represents a block address of the directory or file in a normal device image calculated according to a format of a normal device image file system. The subdirectory B 810 may comprise a directory record for subdirectory B, a directory record for the parent (root) directory, a directory record for the file B1, a directory record for the file B2, etc. The directory record for each directory or file may comprise the block address of the contents of the directory or file, and such block address is also recorded in the logical block address table 802. The block address represents a block address of the contents of the directory or file in a normal device image calculated according to a format of a normal device image file system.

Pointers are stored in the logical block address table 802 that point from the recorded multiple block addresses to the real positions for the volume descriptor 806, the root directory 808, the subdirectory B 810, the file A1, the file B1, the file B2, etc. Since the addresses of the volume descriptor 806, the root directory 808, and the subdirectory B 810 in the virtual image file header 804 are adjusted with respect to a normal device image upon generation of the virtual image file header 804, the real positions of these components in the virtual image file header 804 are changed with respect to their block addresses in the normal device image. Maps from the block addresses of the volume descriptor 806, the root directory 808, and the subdirectory B 810 in the normal device image to their real positions in the virtual image file header 804 are formed in the logical block address table 802. The volume descriptor 806, the root directory 808, and the subdirectory B 810 are placed into real positions in the virtual device image 801 in accordance with the corresponding address map relationship, thus reducing the storage space of the virtual device image 801.

The real positions of the specific contents of the file A1, the file B1, and the file B2 are their addresses in the external file system 812. Maps from the block addresses of the file A1, the file B1 and the file B2 to their real positions in the external file system 812 are also formed in the logical block address table 802, and there are link paths pointing to the external file system 812 in the maps. For example, as illustrated in FIG. 8, there is a path “/A1” pointing to the file A1 in the block address YY-ZZ of the file A1 of the logical block address table 802, there is a path “/B/B1” pointing to the file B1 in the block address ZZ-AA for the file B1 of the logical block address table 802, and there is a path “/B/B2” pointing to the file B2 in the block address AA-BB for the file B2 of the logical block address table 802. The contents of the target files, (i.e., the specific contents of the file A1, the file A2 and the file B2) are stored in the external file system 812.

According to another exemplary embodiment, the aforementioned method for mounting at least one file and/or directory to a local or remote host further comprises the step of generating a directory record in the virtual image file header 804 for at least one file and/or directory to be mounted (e.g., a directory record of the file A1) and writing information regarding the calculated block address and the size of the occupied space into the directory record of the at least one file and/or directory.

According to another exemplary embodiment, the aforementioned method for mounting at least one file and/or directory to a local or remote host further comprises the step of adjusting the position of the volume descriptor 806 in the virtual image file header 804, which is the real position of the volume descriptor 806 in the virtual image file header 804. If at least one directory is mounted to the local or remote host, the method further may comprise the step of adjusting the position of the at least one directory in the virtual image file header 804, which is the real position of the at least one directory in the virtual image file header 804.

Also recorded in the logical block address table 802 is information regarding the block address and the size of the occupied space of the volume descriptor 806, as well as a map from the block address to the real position of the volume descriptor 806 in the virtual image file header 804.

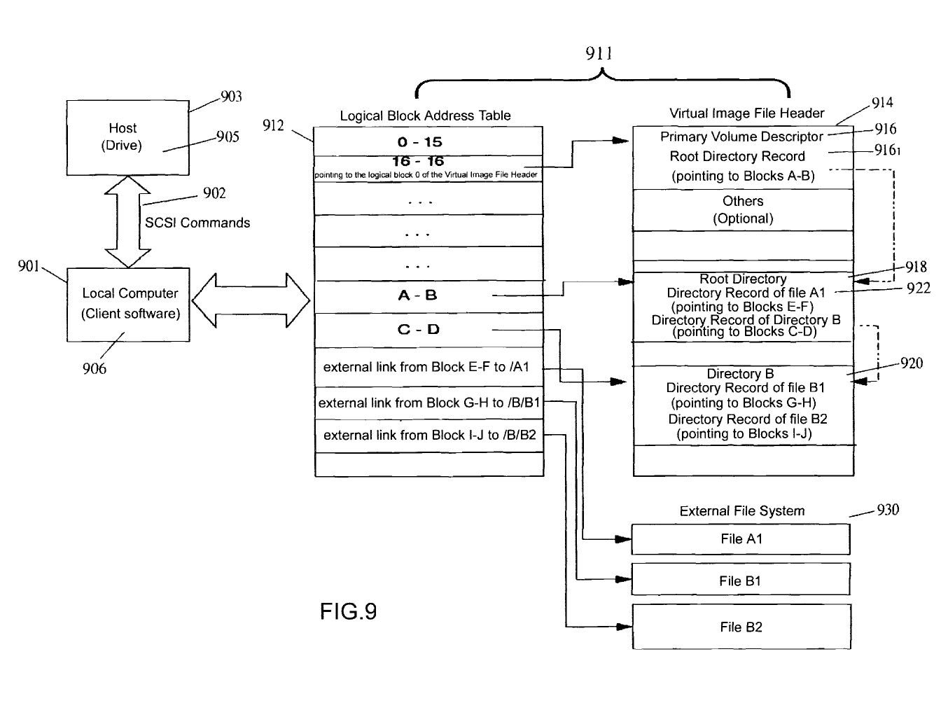

FIG. 9 shows a diagram of an exemplary system for mounting at least one file and/or directory to a local or remote host according to an exemplary embodiment. As shown in FIG. 9, a local computer 901 comprises a variety of files and directories. A remote drive 905 is installed in a host 903, which is connected with the local computer 901 via a network 902. The local computer 901 may interface with a virtual device image 911, which may comprise a logical block address table 912 and optionally a virtual image file header 914. The virtual image file header 914 may comprise one or more volume descriptor components (including a primary volume descriptor 916 and a root directory record 916i), a root directory 918 comprising a directory record 922 for the file A1, and a subdirectory B 920 comprising directory records for the file B1 and the file B2. Each directory record may comprise written information regarding the block address and the size of the occupied space. The logical block address table 912 may interface with the virtual image file header 914 and an external file system 930. The external file system 930 is located outside of the virtual device image 911. Client software 906 of the remote drive 905 may run on the local computer 901. The local computer 901 may mount an arbitrary number of files or directories therein to the host 903 (e.g., disk drives (E:), (F:), etc.) to be used in the host 903 by running the client software 906 for the remote drive 905.

According to an exemplary embodiment, the remote drive 905 is not limited to installation in the host 903; rather, the remote drive 905 also may be installed in the local computer 901 or in a third-party device. According to another exemplary embodiment, the host 903 and the local computer 901 may be integrated into the same device and may be used in conjunction with methods as described herein regarding the exemplary embodiments.

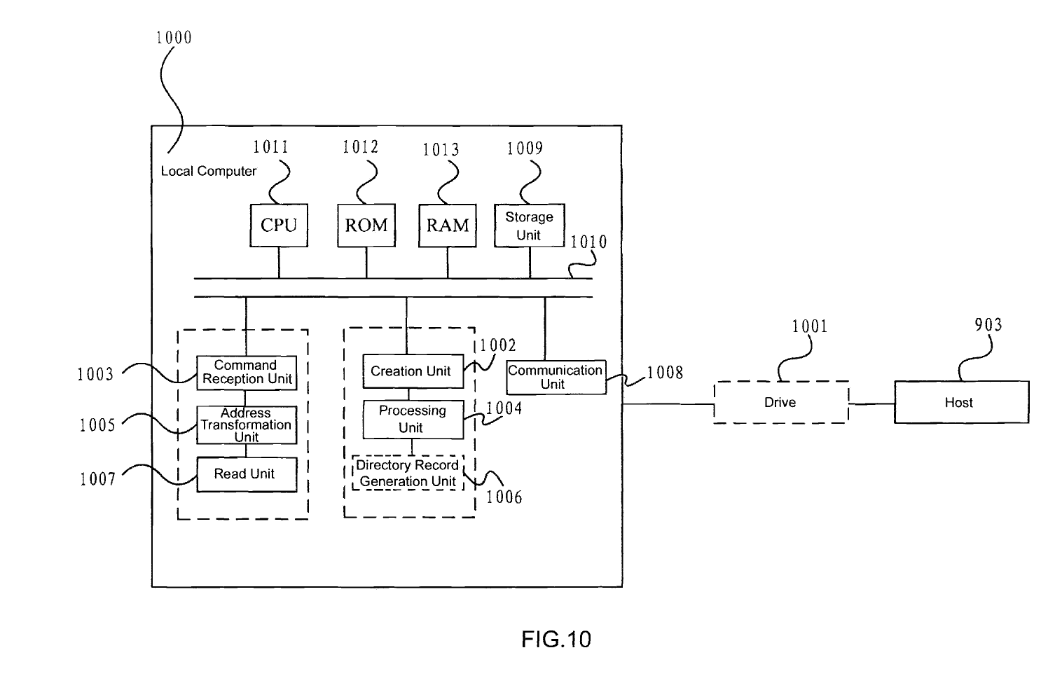

FIG. 10 is a structural diagram of an apparatus for mounting at least one file and/or directory to a local or remote host and/or for reading the content of a virtual device image from the host in accordance with an exemplary embodiment. As shown in FIG. 10, a local computer 1000 is capable of communicating with the host 903 and performing the operations of mounting an arbitrary number of files or directories to the host 903 via a drive 1001 and reading the content of the file or directory from the host 903. The local computer 1000 may comprise a central processing unit (CPU) 1011 for executing system software and application software to handle data and to control the operation of respective components (units) in the local computer 1000, a read only memory (ROM) 1012 for storing various programs required for execution of process and control by the CPU 1011, a random access memory (RAM) 1013 for storing intermediate data temporarily generated by the CPU 1011, a communication unit 1008 connected with the host 903 via wired network and/or wireless network (not shown) for transmitting data and/or commands between the local computer 1000 and the host 903, and a storage unit 1009 for storing the data and/or commands received and/or transmitted. According to another exemplary embodiment, the local computer 1000 may further comprise a creation unit 1002, a processing unit 1004, a (SCSI) command reception unit 1003, an address transformation unit 1005, and a read unit 1007. Additionally, the local computer 1000 may comprise a directory record generation unit 1006. The CPU 1011 executes control programs in order to complete various functions and operations via the aforementioned units. The aforementioned units are interconnected via a bus 1010.

The structure of the local computer 1000 as provided in FIG. 10 is only for illustration in accordance with an exemplary embodiment and does not limit the scope of such structure. In accordance with alternative embodiments, one or more of the aforementioned units may be omitted, and functions of the aforementioned units may be incorporated into one unit or may be divided into multiple smaller units. For instance, in accordance with an exemplary embodiment, the creation unit 1002, the processing unit 1004, and the directory record generation unit 1006 may be individually formed as an apparatus for mounting at least one file and/or directory to a local or remote host, while the command reception unit 1003, the address transformation unit 1005, and the read unit 1007 may be individually formed as an apparatus for reading the virtual device image.

According to an exemplary embodiment, the local computer 1000 performs the operations required to mount at least one file and/or directory. More specifically, the creation unit 1002 creates the virtual device image 911, which comprises the logical block address table 912 and optionally the virtual image file header 914, for at least one file and/or directory to be mounted. The processing unit 906 writes into the logical block address table 912 information regarding the block address and the size of the occupied space of the specific content of the at least one file and/or directory calculated according to a format of a normal device image file system. Moreover, the processing unit 906 records the relevant address map relationship(s) (i.e., the file address map relationship and/or the directory address map relationship) in the logical block address table 912. The drive 1001 mounts the created virtual device image 911 to the host 903. In FIG. 10, the mounted virtual device image 911 behaves as a local drive of the host 903 (e.g., in a way similar to local drives with identifiers of (E:), (F:), (G:), etc.). The specific contents of any files or files included in any directory are located in the external file system 930 outside of the virtual device image 911.

According to an exemplary embodiment, the host 903 identifies the virtual device image 911 as a local drive. The manner in which the host 903 performs detection and identification of the virtual device image 911 is the same as the manner in which the host 903 performs detection and identification of physically connected devices.

According to another exemplary embodiment, the drive 1001 may be located inside the local computer 1000 such that the drive 1001 and the local computer 1000 operate as a single unit. Alternatively, the drive 1001 may be located outside of the local computer 1000; for instance, the drive 1001 may be installed in the host 903 or in a third-party device.

According to an exemplary embodiment, the file address map relationship includes a map from the block address of any file to the real position of its specific content located outside of the virtual device image 911, and the directory address map relationship includes a map from the block address of any directory to the real position of its specific content in the virtual device image 911. The address map relationship for any file in a directory can be considered as a kind of file address map relationship.

According to an exemplary embodiment, the directory record generation unit 1006 generates a directory record for the at least one file and/or directory to be mounted in the virtual image file header 914 and writes the information regarding the calculated block address and the size of the occupied space into the directory record of the at least one file and/or directory. Moreover, in accordance with another exemplary embodiment, the processing unit 1004 is used to adjust the position of the volume descriptor 916 in the virtual image file header 914, which is the real position of the volume descriptor 916 in the virtual image file header 914. If at least one directory is mounted to the local or remote host 903, the processing unit 1004 further is used to adjust the position of the least one directory in the virtual image file header 914, which is the real position of the at least one directory in the virtual image file header 914.

According to an exemplary embodiment, information regarding the block address and the size of the occupied space of the volume descriptor 916, as well as the map from the block address to the real position of the volume descriptor 916 in the virtual image file header 914, are recorded in the logical block address table 912.

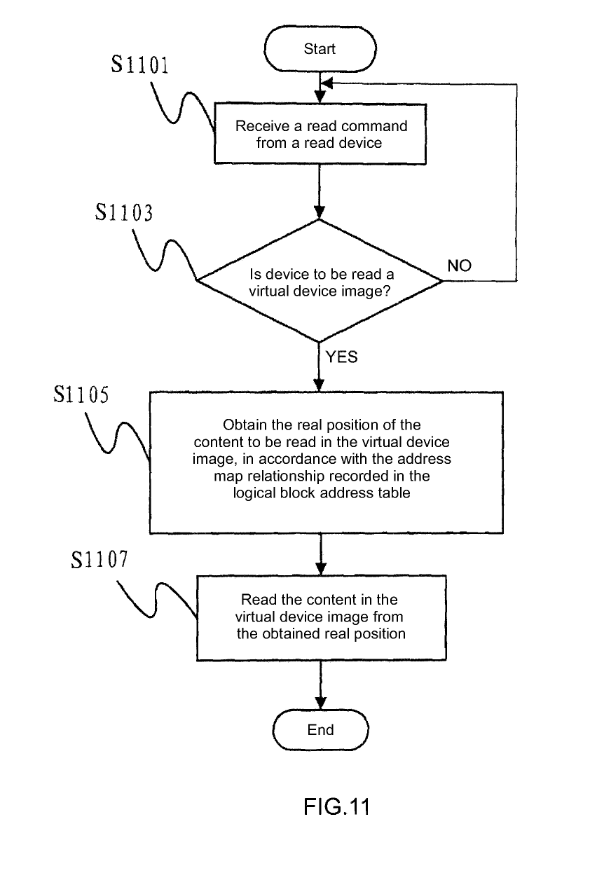

FIG. 11 is a flowchart illustrating a method for reading a virtual device image (e.g., the virtual device image 911) according to an exemplary embodiment. In accordance with the exemplary embodiment, the real position of the specific content of any file and/or a file included in any directory is located outside of the virtual device image. Specifically, the local computer 1000 may perform read operations with respect to the virtual device image 911 via the following process steps. At step S1101, the command reception unit 1003 receives a read command from a read device such as the host 903. Subsequently, at step S1103, the command reception unit 1003 determines whether or not the device to be read is a virtual device image. If it is determined at step S1103 that the device to be read is a virtual device image, the process proceeds to step S1105. Otherwise, the process returns to step S1101.

At step S1105, the address transformation unit 1005 obtains the real position of the content to be read in the virtual device image 911, in accordance with the address map relationship (file address map relationship and/or directory address map relationship) recorded in the logical block address table 912 of the virtual device image 911. Also recorded in the logical block address table 912 is information regarding the block address and the size of the occupied space of the specific content of the at least one file and/or directory calculated according to a format of a normal device image file system. If the virtual device image 911 contains at least one file, the file address map relationship comprises a map from the block address of the at least one file to the real position of the at least one file located outside of the virtual device image 911. If the virtual device image 911 contains at least one directory, the directory address map relationship comprises a map from the block address of the at least one directory to the real position of the specific content of the at least one directory in the virtual device image 911. If the at least one directory contains a file, the address map relationship for the file can be considered as a kind of file address map relationship. Subsequently, at step S1107, the read unit 1007 reads the content in the virtual device image 911 from the obtained real position. Finally, the process may end.

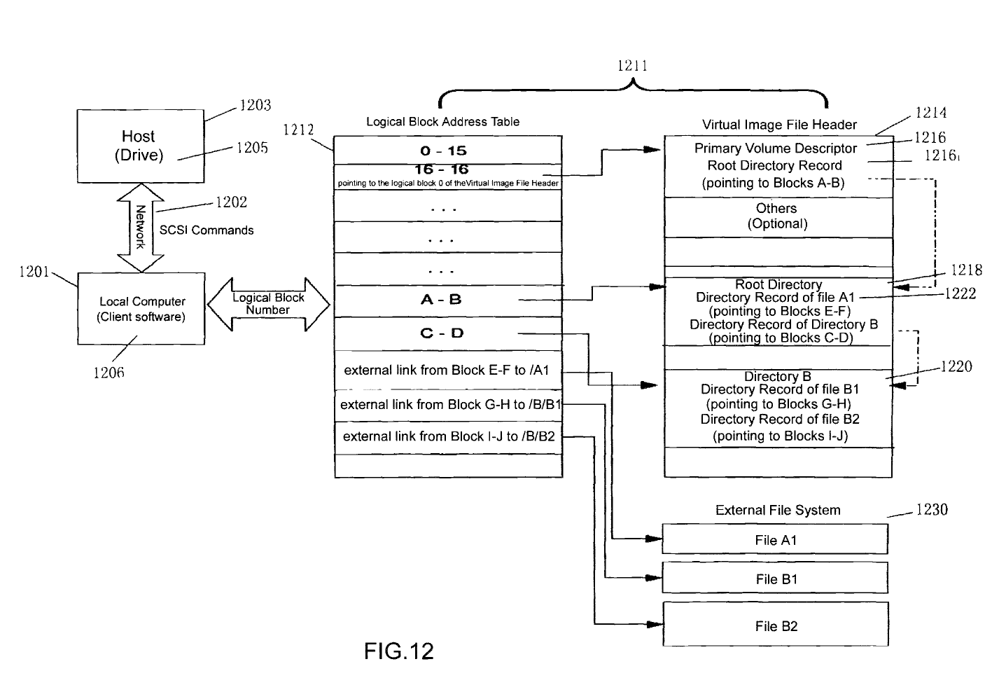

FIG. 12 is a diagram of a system for reading at least one file and/or directory in the virtual device image mounted onto a local or remote host according to another exemplary embodiment. The system illustrated in FIG. 12 is similar to the system illustrated in FIG. 9. As shown in FIG. 12, a local device (e.g., local computer) 1201 is connected with a host 1203 via a network 1202. Client software 1206 of a drive 1205 runs on the local device 1201. The structure of the local device 1201 is the same as that of the local computer 1000 as shown in FIG. 10. A created virtual device image 1211 of the file or directory is presented as a local drive on the host 1203. The virtual device image 1211 comprises a logical block address table 1212 and a virtual image file header 1214. The logical block address table 1212 interfaces with the virtual image file header 1214 and an external file system 1230. The virtual image file header 1214 comprises volume descriptor components (e.g., a primary volume descriptor 1216 and a root directory record 1216i), a root directory 1218 comprising one or more directory records (e.g., directory record 1222 of the file A1), a subdirectory B 1220, etc.

According to an exemplary embodiment, the local device 1201 receives a command sent from the host 1203. The sent command may be a SCSI command in compliance with the SCSI command set specification. Each of the read and write SCSI commands has two fields, with one field indicating the identity of the first block from which data is to be read or to which data is to be written by the host 1203, and the other field indicating the number of blocks to be read or written. The number of the first block herein refers to the block address of the data to be read or written as known by the host 1203 with respect to a normal device image. Upon receiving a SCSI command from the host 1203, the client software 1206 running on the local device 1201 obtains the real position of the content of the file or directory from the logical block address table 1212 of the virtual device image 1211 in accordance with the block address to be read as indicated in the SCSI command, and subsequently obtains the content of the file or directory from the real position. Respective functions of the client software 1206 may be implemented by the command reception unit 1003, the address transformation unit 1005, the read unit 1007, etc., as illustrated in FIG. 10.

Read operations with respect to the virtual device image 1211 now will be described via an example with reference to FIG. 12. Firstly, the command reception unit 1003 of the local device 1201 receives a SCSI command, in which the starting block address (e.g., 16-16) of the volume descriptor 1216 to be read is included, from the host 1203 via the communication unit 1008. Once it is determined that the device to be read is a virtual device image, the address transformation unit 1005 obtains the real position of the starting block address (16-16) in the virtual image file header 1214, which is the position of the volume descriptor 1216 after adjustment in the virtual image file header 1214, from the address map of the logical block address table 1212. In this example, the real position of the starting block address (16-16) is the logical block 0 (i.e., the first block) of the virtual image file header 1214. Then, the read unit 1007 reads the data of the volume descriptor 1216. The data of the volume descriptor 1216 is returned to the host 1203 via the communication unit 1008.

The host 1203 receives the volume descriptor 1216, obtains the root directory record 1216i from the volume descriptor 1216, and extracts the block address of the root directory 1218 from the root directory record 1216i, which is A-B. Then, the host 1203 issues a command to read the content of the block A-B. The address transformation unit 1005 of the local device 1201 acquires the real position of the content of the block address A-B in the virtual image file header 1214, which is the root directory 1218, via the corresponding address map in the logical block address table 1212. Then, the read unit 1007 reads the content of the root directory 1218 and returns the content of the root directory 1218 to the host 1203 via the communication unit 1008.

The host 1203 receives the content of the root directory 1218, obtains for example the directory record 1222 of the file A1 from the content of the root directory 1218, and abstracts the block address of the content of the file A1 from the directory record 1222, that is, E-F. Then, the host 1203 issues a command to read the content of the block address E-F. Then, the address transformation unit 1005 in the local device 1201 acquires the real position of the content of the block address E-F of file A1 in the external file system 1230, according to the corresponding address map in the logical block address table 1212. Subsequently, the read unit 1007 reads the content of the file A1 from outside of the virtual device image 1211 in accordance with the path “/A1” in the logical block address table 1212 and organizes the corresponding content into an appropriate format, e.g., the format in compliance with ISO 9660 specification. Then, the local device 1201 returns the file A1 organized into an appropriate format to the host 1203 via the communication unit 1008. In this way, the host 1203 is capable of accessing the content of the file and/or directory of the virtual device image 1211 identified as the local drive on the host 1203.

The above read operations are not intended to limit the scope of the various embodiments described herein. In accordance with other embodiments, the host 1203 may complete the above read operations via other means.

In accordance with an exemplary embodiment, the client software 1206 of the local computer 1201 does not read from the virtual device image 1211 itself when reading data of the specific content of a file. Moreover, read operations can be accomplished via the local computer 1201 and need not be visible to the host 1203.

The various embodiments described herein may be applied to any device with a remote drive function. The various embodiments may be realized by hardware, software, firmware, or combinations thereof. The implementations of the various embodiments do not limit their scope, nor do the relationships between respective functional elements (units) of the various embodiments. One or more functional elements among the various embodiments may include or be associated with any other functional elements.

According to an exemplary embodiment, the virtual device image may be a virtual ISO image file. However, the virtual ISO image file does not limit the scope of the various embodiments described herein. Rather, the virtual device image according to the various embodiments may be a virtual device image of any other types and/or formats.

Although exemplary embodiments have been described above with reference to the attached drawings, it should be understood to those skilled in the art that variations and modifications may be made to these embodiments without departing from the principle and spirit of the disclosure.

What is claimed is:

1. A method for mounting at least one file to a host, the method comprising:
creating a virtual device image comprising a logical block address table;
writing information regarding a block address and a size of an occupied space of the at least one file into the logical block address table, the information being calculated according to a format of a normal device image file system;
recording in the logical block address table a file address map relationship comprising a map from the block address of the at least one file to a real position of the at least one file outside of the virtual device image; and
mounting the virtual device image to the host.

2. The method according to claim 1, wherein the virtual device image further comprises a virtual image file header, and wherein the method further comprises generating a directory record of the at least one file in the virtual image file header and writing the information regarding the block address and the size of the occupied space of the at least one file into the directory record of the at least one file.

3. The method according to claim 2, the method further comprising:
writing information regarding a block address and a size of an occupied space of at least one directory to be mounted into the logical block address table, the information being calculated according to a format of a normal device image file system; and
recording in the logical block address table a directory address map relationship comprising a map from the block address of the at least one directory to a real position of the at least one directory in the virtual image file header.

4. The method according to claim 3, the method further comprising:
generating a directory record of the at least one directory in the virtual image file header; and
writing the information regarding the block address and the size of the occupied space of the at least one directory into the directory record of the at least one directory.

5. The method according to claim 4, the method further comprising placing the at least one directory into the real position of the at least one directory according to the directory address map relationship.

6. The method according to claim 4, wherein the virtual image file header further comprises a volume descriptor, wherein the method further comprises adjusting a position of the volume descriptor in the virtual image file header from a block address of the volume descriptor to a real position of the volume descriptor in the virtual image file header, and wherein information regarding the block address and a size of an occupied space of the volume descriptor and a map from the block address of the volume descriptor to the real position of the volume descriptor are recorded in the logical block address table.

7. An apparatus for mounting at least one file to a host, the apparatus comprising:
a creation unit for creating a virtual device image comprising a logical block address table;
a processing unit for writing information regarding a block address and a size of an occupied space of the at least one file into the logical block address table, the information being calculated according to a format of a normal device image file system, and for recording in the logical block address table a file address map relationship comprising a map from the block address of the at least one file to a real position of the at least one file outside of the virtual device image; and
a drive for mounting the virtual device image to the host.

8. The apparatus according to claim 7, wherein the virtual device image further comprises a virtual image file header, and wherein the apparatus further comprises a directory record generation unit for generating a directory record of the at least one file in the virtual image file header and for writing the information regarding the block address and the size of the occupied space of the at least one file into the directory record of the at least one file.

9. The apparatus according to claim 8, wherein the processing unit further writes information regarding a block address and a size of an occupied space of at least one directory to be mounted into the logical block address table, the information being calculated according to a format of a normal device image file system, and wherein the processing unit further records in the logical block address table a directory address map relationship comprising a map from the block address of the at least one directory to a real position of the at least one directory in the virtual image file header.

10. The apparatus according to claim 9, wherein the directory record generation unit further generates a directory record of the at least one directory in the virtual image file header and writes the information regarding the block address and the size of the occupied space of the at least one directory into the directory record of the at least one directory.

11. The apparatus according to claim 10, wherein the processing unit further places the at least one directory into the real position of the at least one directory according to the directory address map relationship.

12. The apparatus according to claim 10, wherein the virtual image file header further comprises a volume descriptor, wherein the processing unit further adjusts a position of the volume descriptor in the virtual image file header from a block address of the volume descriptor to a real position of the volume descriptor in the virtual image file header, and wherein information regarding the block address and a size of an occupied space of the volume descriptor and a map from the block address of the volume descriptor to the real position of the volume descriptor are recorded in the logical block address table.

13. A method for reading a virtual device image used to mount at least one file to a host, the method comprising:
receiving a command from a read device regarding content to be read;
obtaining a real position of the content to be read in the virtual device image according to a file address map relationship, the file address map relationship comprising a map from a block address of the at least one file to a real position of the at least one file outside of the virtual device image; and
reading the content from the real position of the at least one file.

14. The method according to claim 13, wherein a logical block address table of the virtual file image comprises the file address map relationship and information regarding the block address and a size of an occupied space of the at least one file, the information being calculated according to a format of a normal device image file system, wherein the virtual device image further comprises a virtual image file header including a generated directory record of the at least one file, and wherein the directory record of the at least one file comprises the information regarding the block address and the size of the occupied space of the at least one file.

15. The method according to claim 14, wherein the logical block address table further comprises information regarding a block address and a size of an occupied space of at least one directory to be mounted, the information being calculated according to a format of a normal device image file system, and wherein the logical block address table further comprises a directory address map relationship including a map from the block address of the at least one directory to a real position of the at least one directory in the virtual image file header.

16. The method according to claim 15, wherein the virtual image file header comprises a generated directory record of the at least one directory, wherein the directory record of the at least one directory comprises the information regarding the block address and the size of the occupied space of the at least one directory, and wherein a position of the at least one directory in the virtual image file header is adjusted from the block address of the at least one directory to the real position of the at least one directory.

17. An apparatus for reading a virtual device image used to mount at least one file to a host, the apparatus comprising:
a command reception unit for receiving a command from a read device regarding content to be read and for determining whether a device to be read in accordance with the command is a virtual device image;
an address transformation unit for obtaining a real position of the content to be read in the virtual device image according to a file address map relationship, the file address map relationship comprising a map from a block address of the at least one file to a real position of the at least one file outside of the virtual device image; and
a read unit for reading the content from the real position of the at least one file.

18. The apparatus according to claim 17, wherein a logical block address table of the virtual device image comprises the file address map relationship and information regarding the block address and a size of an occupied space of the at least one file, the information being calculated according to a format of a normal device image file system, wherein the virtual device image further comprises a virtual image file header including a generated directory record of the at least one file, and wherein the directory record of the at least one file comprises the information regarding the block address and the size of the occupied space of the at least one file.

19. The apparatus according to claim 18, wherein the logical block address table further comprises information regarding a block address and a size of an occupied space of at least one directory to be mounted, the information being calculated according to a format of a normal device image file system, and wherein the logical block address table further comprises a directory address map relationship including a map from the block address of the at least one directory to a real position of the at least one directory in the virtual image file header.

20. The apparatus according to claim 19, wherein the virtual image file header comprises a generated directory record of the at least one directory to be mounted, wherein the directory record of the at least one directory comprises the information regarding the block address and the size of the occupied space of the at least one directory, and wherein a position of the at least one directory in the virtual image file header is adjusted from the block address of the at least one directory to the real position of the at least one directory.
